(19) United States
(12) Patent Application Publication
(10) Pub. No.: US 2015/0371027 A1
(43) Pub. Date: Dec. 24, 2015

(54) MEMORY SYSTEM, MEMORY CONTROLLER AND METHOD OF CONTROLLING MEMORY SYSTEM

(71) Applicant: Kabushiki Kaisha Toshiba, Minato-ku (JP)

(72) Inventors: Ryuichi KITAJIMA, Funabashi (JP); Kazuya NARA, Kawasaki (JP)

(73) Assignee: Kabushiki Kaisha Toshiba, Minato-ku (JP)

(21) Appl. No.: 14/476,895

(22) Filed: Sep. 4, 2014

Related U.S. Application Data
(60) Provisional application No. 62/013,867, filed on Jun. 18, 2014.

(51) Int. Cl. G06F 21/35; G06F 12/14

(52) U.S. Cl. CPC G06F 21/35; G06F 12/1483

(57) ABSTRACT

According to an embodiment, a memory device includes: a first controller configured to register, to a first memory, access restriction information received over a short-range radio communication by using power generated in the short-range radio communication; and a second controller configured to, at a startup of the memory device, read the access restriction information registered in the first memory and perform an access restriction to a file stored in a second memory based on the read access restriction information.

### CROSS-REFERENCE TO RELATED APPLICATIONS

This application is based upon and claims the benefit of priority from U.S. Provisional Patent Application No. 62/013,867, filed on Jun. 18, 2014, the entire contents of which are incorporated herein by reference.

### FIELD

Embodiments described herein relate generally to a memory device equipped with a short-range radio communication chip, a memory controller, and a control method of the memory device.

### BACKGROUND

Memory cards are equipped with a nonvolatile memory such as a flush memory. When memory card is loaded into a card slot of a host device, the nonvolatile memory in the memory card can be accessed from the host device.

On the other hand, attention has been paid to NFC tugs including the antenna and the chip having the NFC (Near Field Communication) function. When the NFC tug is put close to the host device having the NFC function, information can be transmitted and received between the NFC tug and the host device.

### BRIEF DESCRIPTION OF THE DRAWINGS

FIG. 1 is a functional block diagram illustrating an internal configuration of a memory card;

FIG. 2 is a diagram illustrating a data mapping of access restriction information;

FIGS. 3A-3F are diagrams illustrating respective portions of a registration procedure of administrator information;

FIGS. 4A-4F are diagrams illustrating respective portions of a registration procedure of user management information;

FIG. 5 is a diagram conceptually illustrating registration operation of access restriction information in a first embodiment;

FIG. 6 is a flowchart illustrating an operation process at a startup of a memory card in the first embodiment;

FIGS. 7A and 7B are diagrams illustrating an example of accessible folders when there is no access restriction and an example of accessible folders when there is an access restriction, respectively, in the first embodiment;

FIG. 8 is a diagram illustrating a mapping of access restriction information in a second embodiment;

FIG. 9 is a flowchart illustrating an operation process at a startup of a memory card in the second embodiment;

FIGS. 10A and 10B are diagrams illustrating an example of accessible folders when there is no access restriction and an example of accessible folders when there is an access restriction, respectively, in the second embodiment;

FIG. 11 is a diagram illustrating a mapping of access restriction information in a third embodiment;

FIG. 12 is a flowchart illustrating an operation process at a startup of a memory card in the third embodiment; and

FIGS. 13A and 13B are diagrams illustrating an example of accessible folders when there is no access restriction and an example of accessible folders when there is an access restriction, respectively, in the third embodiment.

### DETAILED DESCRIPTION

In general, according to the present embodiment, a memory device includes a nonvolatile first memory, a nonvolatile second memory having a larger capacity than the first memory, a first controller, and a second controller. The first controller registers, to the first memory, access restriction information received over a short-range radio communication by using the power generated in the short-range radio communication. At the startup of the memory device, the second controller reads access restriction information registered in the first memory and performs an access restriction to a file stored in the second memory based on the read access restriction information.

Exemplary embodiments of a memory device, a memory controller, and a control method of the memory device will be described below in detail with reference to the accompanying drawings. The present invention is not limited to the following embodiments.

### First Embodiment

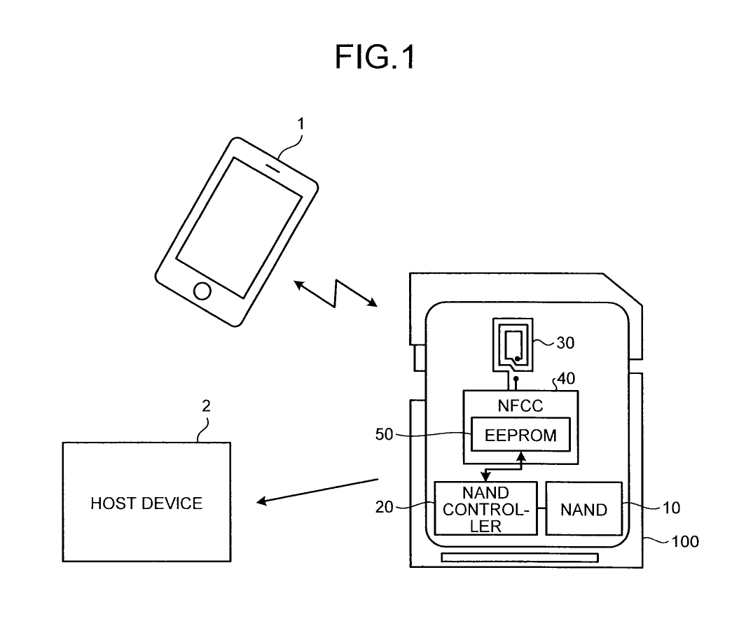

FIG. 1 is a block diagram illustrating an internal configuration example of a memory card 100 as a memory device of the embodiment. The memory card 100 has a short-range radio communication function of the NFC (Near Field Communication) standard. Other standards such as the Transfer Jet may be employed for the short-range radio communication function. The memory card 100 is made available when inserted in a card slot of a host device 2 such as a smartphone, a cellular phone, a PC (Personal Computer), or the like. The host device 2 may be a device supporting the NFC or a device not supporting the NFC. A host device 1 is a mobile terminal such as a smartphone, a cellular phone, a tablet, or the like, for example. The host device 1 is the NFC-supported device and is capable of the NFC-communication with the memory card 100. While an SD card is employed here as the memory card, other memory cards such as a USB memory, an SIM card, an IC card, and the like may be employed.

The memory card 100 includes a NAND-type flash memory (hereafter, referred to as “NAND”) 10 as the nonvolatile memory, a NAND controller 20 configured to control the NAND 10, an antenna 30 supporting the NFC, an NFC controller (NFCC) 40, and a nonvolatile temporary memory 50 such as an EEPROM (Electrically Erasable Programmable Read-Only Memory).

When the memory card 100 is loaded into the host device 2, the user data designated by the host device 2 is stored in the NAND 10. The NAND 10 includes one or a plurality of memory chips. Each of the memory chips has a plurality of memory cells array in a matrix. Each of the memory cells is able to store multiple values. Each memory chip is configured by arranging a plurality of physical blocks being units of data erasing. Each of the physical blocks includes a plurality of physical pages. In the NAND 10, data write and data read are performed for each physical page.

The NAND controller 20 executes the command processing corresponding to each command received from the host device 2 when the memory card 100 is loaded into the host device 2. This command processing includes the process of reading data from the NAND 10, the process of writing data to the NAND 10, and so on. The NAND controller 20 controls the NAND 10 by using management information such as logical-physical translation information indicating the mapping of the logic address used in the host device 2 with the physical address of the NAND 10 used in the memory card 100. The NAND controller 20 executes the internal process to the NAND 10, such as the garbage collection process, the ware-leveling process, and the like in addition to the above.

The antenna 30 is an antenna for the NFC-communication, and performs transmission and reception of information with the antenna of the NFC-supported host device 1 that is put close to the memory card 100. The NFC controller 40 and the EEPROM 50 are able to operate even under the situation where the memory card 100 is not supplied with the power source. That is, in response to the action where the NFC-supported host device 1 is put close to the antenna 30 or the antenna 30 is put close to the host device 1, a magnetic field is generated from the host device 1 and the magnetic field causes an induced electromotive force to occur at the antenna 30. The induced electromotive force is utilized to operate the NFC controller 40 and the EEPROM 50.

The EEPROM 50 is a writable nonvolatile memory and is able to be accessed by the NFC controller 40 and the NAND controller 20. The data written in the EEPROM 50 can be recognized, through the NFC-communication, by the NFC-supported host device 1. Even when the memory card 100 is loaded into the card slot of the host device 2, however, the data written in the EEPROM 50 cannot be recognized by the non-NFC-supported host device 2. Any memory other than the EEPROM may be employed for a temporary memory 50 as long as it has a smaller capacity than the NAND 10, consumes less power, and is capable of the high speed access. In the EEPROM 50, the access restriction information to a file within the NAND 10 from the host device 1 is registered via the NFC controller 40.

The NFC controller 40 performs NFC-communication with the host device 1 via the antenna 30. The NFC communication allows the application installed in the host device 1 to write the data to the EEPROM 50 via the NFC controller 40 and read the data from the EEPROM 50. The reading/writing of the data from the application of the host device 1 to the EEPROM 50 is possible even when the memory card 100 is not inserted in the card slot and is not supplied with the power source, as described above.

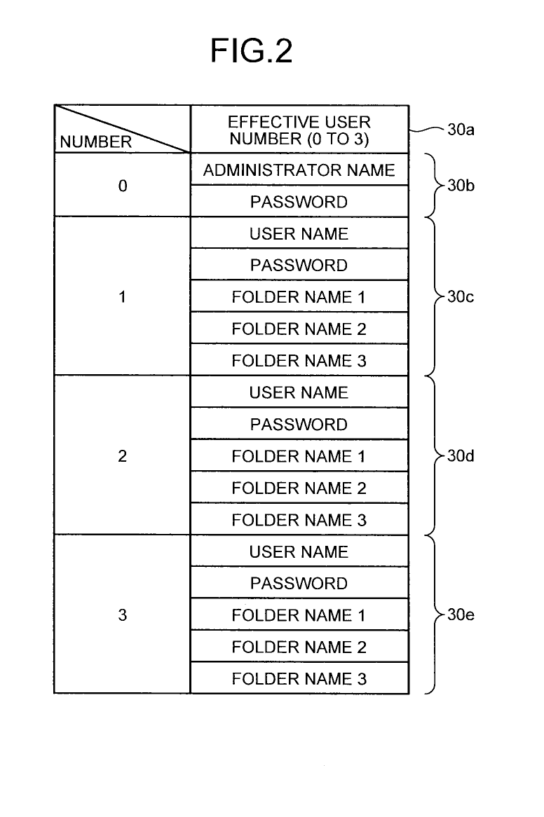

FIG. 2 illustrates a mapping of the access restriction information registered to the EEPROM 50 from the host device 1. The access restriction information is to perform the access restriction to the file within the NAND 10 by using the metadata for identifying the file stored in the NAND 10. The access restriction is set on a user basis. In the first embodiment, the folder name is used as the metadata and the access restriction is thus set on a folder basis. That is, in the first embodiment, the folder to be made accessible in the NAND 10 is restricted on a user basis.

In FIG. 2, the access restriction information includes an effective (valid) user number 30a, administrator information 30b, and multiple pieces of user management information 30c to 30e. The effective user number 30a is used for identifying the accessible current user. In the entry of the user number 0, the administrator information 30b is registered. In the administrator information 30b, a administrator name and a password are registered.

In the entry of the user number 1, the user management information 30c for the first user is registered. The user management information 30c includes a mapping of a user name, a password, and one or a plurality of folder names within the NAND 10 which is accessible from the first user. In the entry of the user number 2, the user management information 30d for the second user is registered. The user management information 30d includes a mapping of a user name, a password, and one or a plurality of folder names within the NAND 10 which is accessible from the second user. In the entry of the user number 3, the user management information 30e for the third user is registered. The user management information 30e includes a mapping of a user name, a password, and one or a plurality of folder names within the NAND 10 which is accessible from the third user.

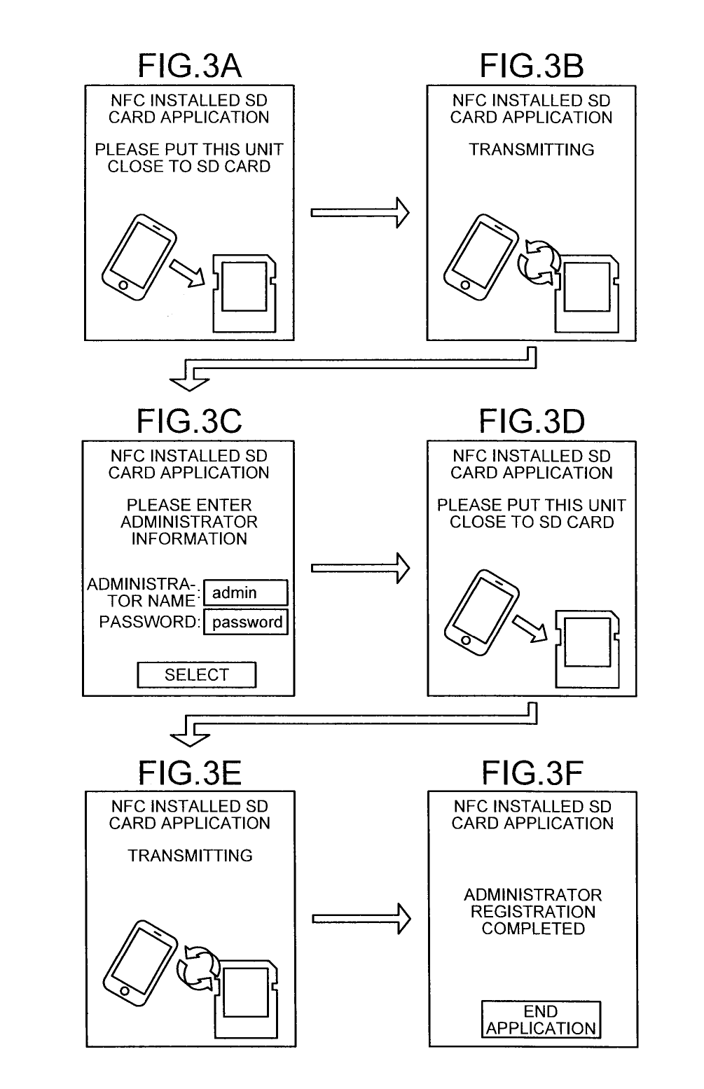

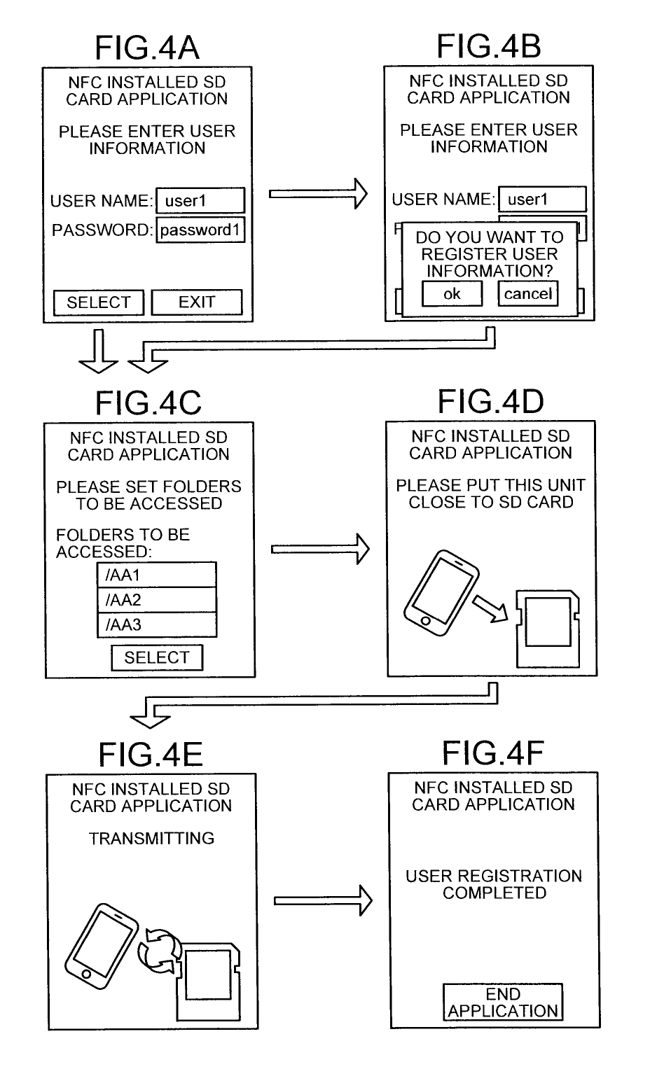

FIGS. 3A-3F and 4A-4F illustrate the flow of the application windows for registering the access restriction information to the EEPROM 50. This application is installed in the host device 1 and has a function of setting the access restriction information in the memory card 100 by using the NFC-communication. FIGS. 3A-3F illustrate the flow of the application windows when the administrator information has not been registered.

Upon starting up of the application, a massage suggesting putting the host device 1 close to the SD card is displayed as illustrated in FIG. 3A. Next, as illustrated in FIG. 3B, a massage indicating that it is during transmission is displayed. Next, as illustrated in FIG. 3C, a window for the entry of the administrator name and the password is displayed. In response to the entry operation of the administrator name and the password and the entry of the select button, the window is switched to a window illustrated in FIG. 3D. In the window illustrated in FIG. 3D, a massage suggesting putting the host device 1 close to the SD card is displayed. Next, as illustrated in FIG. 3E, a massage indicating that it is during transmission is displayed. Next, as illustrated in FIG. 3F, a massage indicating that the administrator registration has been completed is displayed. The above registration operation causes the NFC controller 40 to register the administrator name and its password to the entry of the administrator information 30b in the EEPROM 50 illustrated in FIG. 2.

FIGS. 4A-4E illustrate the flow of the application windows for registering the user information after the registration of the administrator information has been completed. First, after the windows illustrated in FIG. 3A and FIG. 3B are displayed, a window for entry of the user name and the password is displayed as illustrated in FIG. 4A. When the user name and the password have already been registered in the EEPROM 50, a window illustrated in FIG. 4C is then displayed. Alternatively, when the user name and the password have not been registered in the EEPROM 50, the displayed are the entered user name and a popup asking whether or not to register the password, as illustrated in FIG. 4B.

In FIG. 4C, a window for designating a plurality of folder names to be made accessible within the NAND 10 is displayed. The user enters one or a plurality of folder names to be made available within the NAND 10 to the window illustrated in FIG. 4C. In this case, at most three folder names can be registered for one user. In response to the entry operation of the folder name and the entry of the select button in the window of FIG. 4C, the window is switched to a window illustrated in FIG. 4D. In the window illustrated in FIG. 4D, a massage suggesting putting the host device 1 close to the SD card is displayed. Next, as illustrated in FIG. 4E, a massage indicating that it is during transmission is displayed. Next, as illustrated in FIG. 4F, a massage indicating that the user registration has been completed is displayed. When this registration operation is for the registration of the first user, the NFC controller 40 registers the user name and its password and one or a plurality of folder names to the entry of the user management information 30c of the EEPROM 50 illustrated in FIG. 2. By repeating the above registration operation, the user management information for at most three users can be registered to the EEPROM 50 over the NFC-communication.

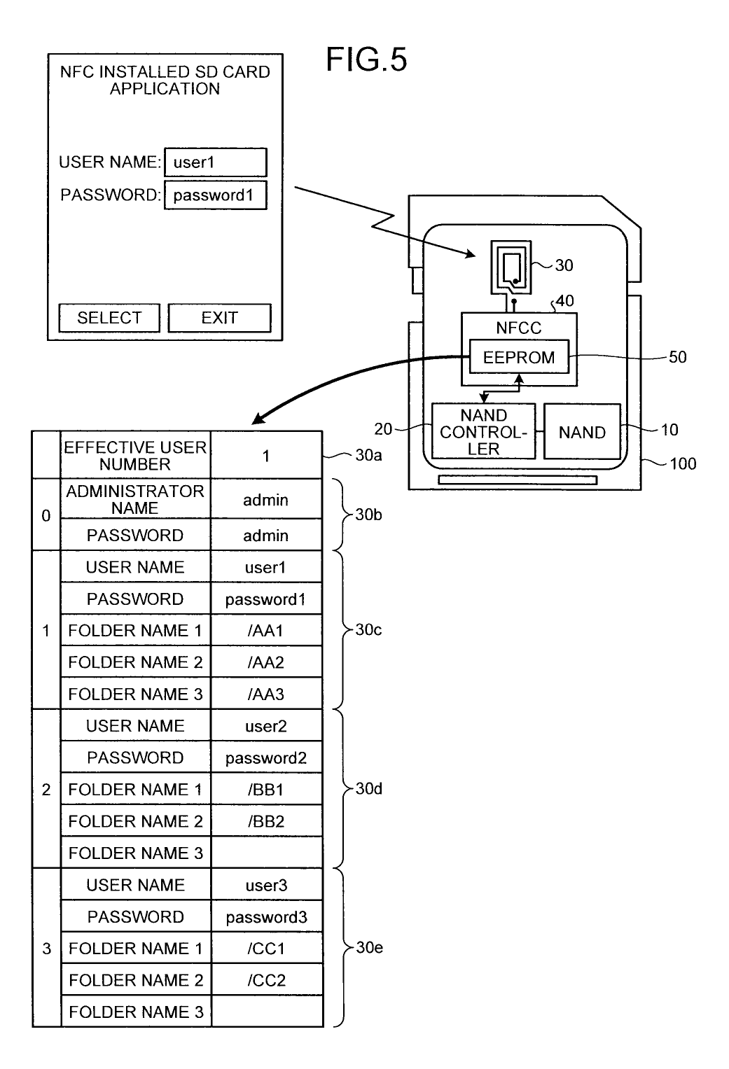

FIG. 5 is a diagram conceptually illustrating the operation at the host device 1 for selecting and enabling one of the multiple pieces of the user information registered in the EEPROM 50. It is assumed that the access restriction information as illustrated in FIG. 5 has been registered in advance in the EEPROM 50. In the access restriction information illustrated in FIG. 5, the first user “user1” has registered three folders “/AA1”, “/AA2”, and “/AA3” as the accessible folders. The second user “user2” has registered two folders “/BB1” and “/BB2” as the accessible folders. The third user “user3” has registered two folders “/CC1” and “/CC2” as the accessible folders.

In order to enable the user management information of the first user “user1”, the user enters the user name “user1” and the password “password1” as illustrated in FIG. 5 in the user selection window in the application of the host device 1 to perform the NFC-communication. The NFC controller 40 compares the user name “user1” and the password “password1” entered via the antenna 30 with the user names and the passwords within the user management information 30c to 30e registered in the EEPROM 50. When there is user management information 30c, 30d, or 30e that matches the user name “user1” and the password “password1” entered from the host device 1, the NFC controller 40 writes, to the area of the effective user number 30a, the user number corresponding to the user management information including the matched user name and password. When there is no user management information 30c to 30e that matches the user name “user1” and the password “password1” entered from the host device 1, the massage indicating that effect is displayed on the above-described user selection window. In the case of FIG. 5, the user number “1” corresponding to the first user “user1” is selected and “1” is written to the area of the effective user number 30a.

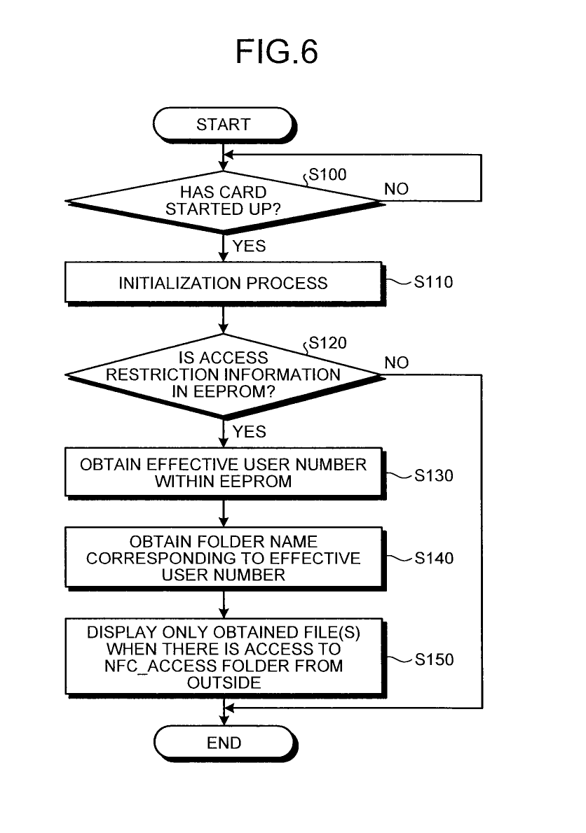

FIG. 6 is a flowchart illustrating the operation procedure at the startup of the memory card 100. In response to the action where the memory card 100 is inserted in the card slot of the host device 2, the memory card 100 is supplied with the power source and then starts up. In response to the startup of the memory card 100 (step S100), the NAND controller 20 executes an initialization process including such as setting the control value for each resistor for the operation control (step S110). In response to the action where the initialization process is started, the NAND controller 20 transmits a busy signal to the host device 2. Then, after the process of step S140 has been completed, the NAND controller 20 transmits a ready signal to the host device 2. Upon receiving the ready signal form the memory card 100, the host device 2 is able to access the file within the NAND 10.

Upon the completion of the initialization process, the NAND controller 20 determines whether or not there is access restriction information written in the EEPROM 50 (step S120) and, if not, terminates the startup process performed at the startup. When having detected access restriction information in the EEPROM 50, the NAND controller 20 acquires the effective user number 30a within the access restriction information from the EEPROM 50 (step S130). Furthermore, the NAND controller 20 acquires, from the EEPROM 50, the folder name registered in the entry of the user management information corresponding to the acquired effective user number 30a (step S140). Then, when there is an access to the folder of the NAND 10 from the host device 2, a part of the folders which corresponds only to the folder name acquired at step S140 is displayed, and only the part of the folders is made accessible (step S150).

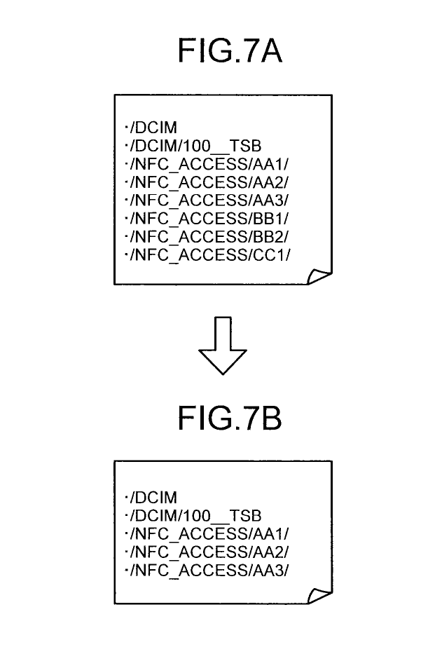

FIG. 7A illustrates a plurality of folders saved in the user area in the NAND 10. The folder “/DCIM” and the folder “/DCIM/100_TSB” are the shared folders to which no access restriction is set. Under the folder “/NFC_ACCESS”, the folders which are accessible by the NFC-communication and non-accessible folders which are not accessible are set. The lower layer of the folder “/NFC_ACCESS” includes the folder “AA1”, the folder “AA2”, the folder “AA3”, the folder “BB1”, the folder “BB2”, and the folder “CC1”.

FIG. 7B illustrates the folders that are visible from the host device 2 at step S150 of FIG. 6 when 1 is set as the effective user number. In this case, since 1 is set as the effective user number, displayed are the shared folders “/DCIM” and “/DCIM/100_TSB” and the folder “/NFC_ACCESS/AA1”, the folder “/NFC_ACCESS/AA2”, and the folder “/NFC_ACCESS/AA3” whose folder names are registered in the user management information 30c of the user number 1, and the files in these folders only are made accessible.

As described above, in the first embodiment, the host device 1 having the NFC-communication function is used to set the folders to be made accessible within the memory card 100 on a user basis. Upon starting up of the card, the access restriction is performed according to the settings in the NFC communication. Therefore, in the first embodiment, the access restriction to the different folders is enabled for each user of the memory card, which allows the user to implement the convenient and specific access restriction. Further, by using the NFC-communication, the access restriction information can be set in a simple manner to the memory card installed in the electronic equipment that has no input device such as a photographing device, a voice recorder, and the like. Further, the NFC-communication allows the access restriction information of the file to be set in the memory card even under the situation where no card slot is provided.

It is noted that, while the folder which is allowed to be accessed is set on a user basis in the above-described embodiment, the folder which is not allowed to be accessed may be set on a user basis. Further, while the folder which is allowed to be accessed is set on a user basis in the above-described embodiment, the file which is allowed to be accessed or the file which is not allowed to be accessed may be set on a user basis. Further, while the access restriction is set for the predetermined folder “/NFC_ACCESS” in the above-described embodiment, the access restriction may be set for all the folders within the NAND 10.

### Second Embodiment

In a second embodiment, the restricted is the extension indicating the type of the file to be made accessible within a NAND 10. In the second embodiment, the extension is used as the metadata and thus an access restriction is set on an extension basis.

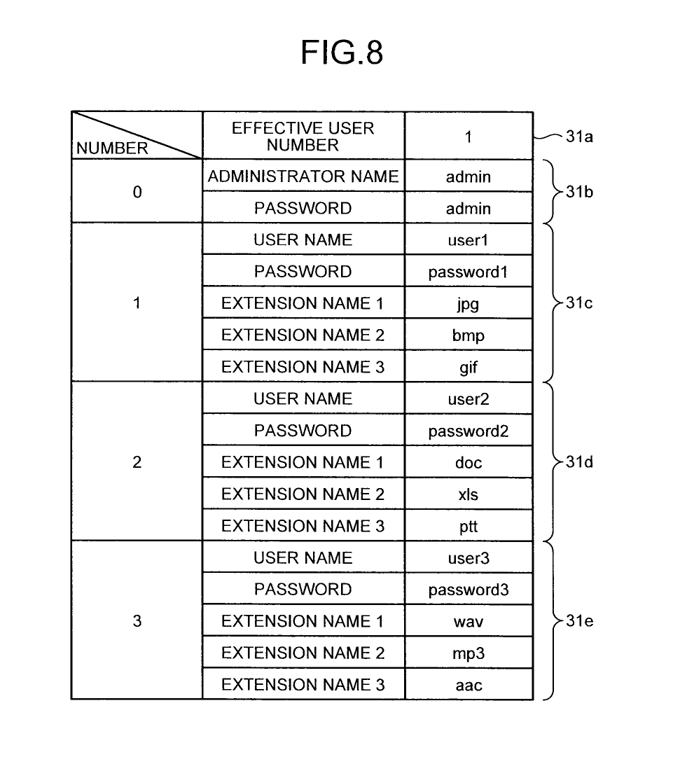

FIG. 8 illustrates a mapping of the access restriction information of the second embodiment. In FIG. 8, the access restriction information includes an effective user number 31a, administrator information 31b, and multiple pieces of user management information 31c to 31e. The effective user number 31a is used for identifying an accessible current user. In the entry of the user number 0, the administrator information 31b is registered. In the administrator information 31b, a administrator name and a password are registered.

The user management information 31c for the first user includes a mapping of a user name, a password, and one or a plurality of extension names within the NAND 10 that is accessible from the first user. The user management information 31d for the second user includes a mapping of a user name, a password, and one or a plurality of extension names within the NAND 10 that is accessible from the second user. The user management information 31e for the third user includes a mapping of a user name, a password, and one or a plurality of extension names within the NAND 10 that is accessible from the third user.

As illustrated in FIG. 8, for the user management information 31c of the first user “user1”, the extensions of the image file, “jpg”, “bmp”, and “gif” are set. For the user management information 31d of the second user “user2”, the extensions of the document file, “doc”, “xls”, and “ptt” are set. For the user management information 31e of the third user “user3”, the extensions of the moving image file, “wav”, “mp3”, and “aac” are set. The registration process of such access restriction information is performed similarly to the process illustrated in FIGS. 3A-3E and FIGS. 4A-4E. Further, the setting procedure of the effective user number is performed also similarly to the procedure illustrated in FIG. 5. In the case of FIG. 8, the user number “1” corresponding to the first user “user1” is selected.

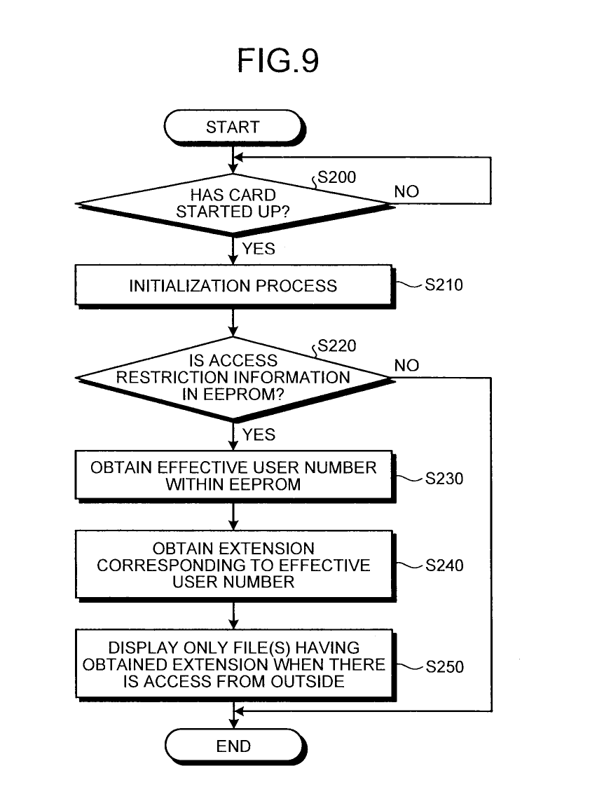

FIG. 9 is a flowchart illustrating the operation procedure at the startup of a memory card 100 in the second embodiment. In response to the action where the memory card 100 is inserted in the card slot of a host device 2, the memory card 100 is supplied with the power source and then starts up. In response to the startup of the memory card (step S200), a NAND controller 20 executes the above-described initialization process (step S210). In response to the action where the initialization process is started, the NAND controller 20 transmits a busy signal to the host device 2. Then, after the process of step S240 has been completed, the NAND controller 20 transmits a ready signal to the host device 2. Upon receiving the ready signal form the memory card 100, the host device 2 is able to access the file within the NAND 10.

Upon completion of the initialization process, the NAND controller 20 determines whether or not there is access restriction information written in an EEPROM 50 (step S220) and, if not, terminates the startup process performed at the startup. When having detected access restriction information in the EEPROM 50, the NAND controller 20 acquires the effective user number 31a within the access restriction information from the EEPROM 50 (step S230). Furthermore, the NAND controller 20 acquires, from the EEPROM 50, the extension name registered in the entry of the user management information corresponding to the acquired effective user number 31a (step S240). Then, when there is an access to the NAND 10 from the host device 2, only a part of the files having the same extension name as the extension name acquired at step S240 is displayed and only the part of the files is made accessible (step S250).

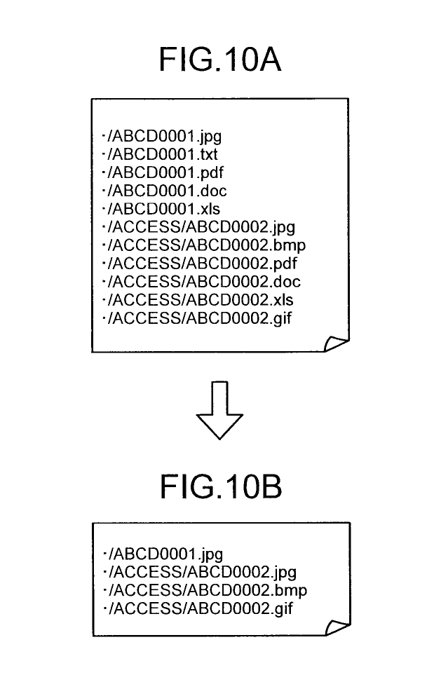

FIG. 10A illustrates a plurality of files saved in the user area in the NAND 10. The saved files include the image files having the extension “jpg”, “bmp”, and “gif”, the document files having the extension “doc” and “xls”, and the text file having the extension “txt”.

FIG. 10B illustrates the files that are visible from the host device 2 at step S250 of FIG. 9 when 1 is set as the effective user number. In this case, since 1 is set as the effective user number, only the image files having the extension “jpg”, “bmp”, and “gif” are displayed and only these files are made accessible.

As described above, in the second embodiment, the host device 1 having the NFC-communication function is used to set the extension of the files to be made accessible within the memory card on a user basis. Upon starting up of the card, the access restriction is performed according to the settings in the NFC communication. Therefore, in the second embodiment, the access restriction to the files having the different extensions is enabled for each user of the memory card, which allows the user to implement the convenient and specific access restriction.

It is noted that, while the extension which is allowed to be accessed is set on a user basis in the above-described second embodiment, the extension which is not allowed to be accessed may be set on a user basis.

### Third Embodiment

In a third embodiment, a timestamp of files to be made accessible within a NAND 10 is restricted. That is, if the timestamp (update time) of a file is within a permissible period that is set on a user basis, that file is made accessible. If the timestamp of a file is out of a permissible period, that file is not made accessible. In the third embodiment, the timestamp is used as metadata and thus an access restriction is performed on the timestamp.

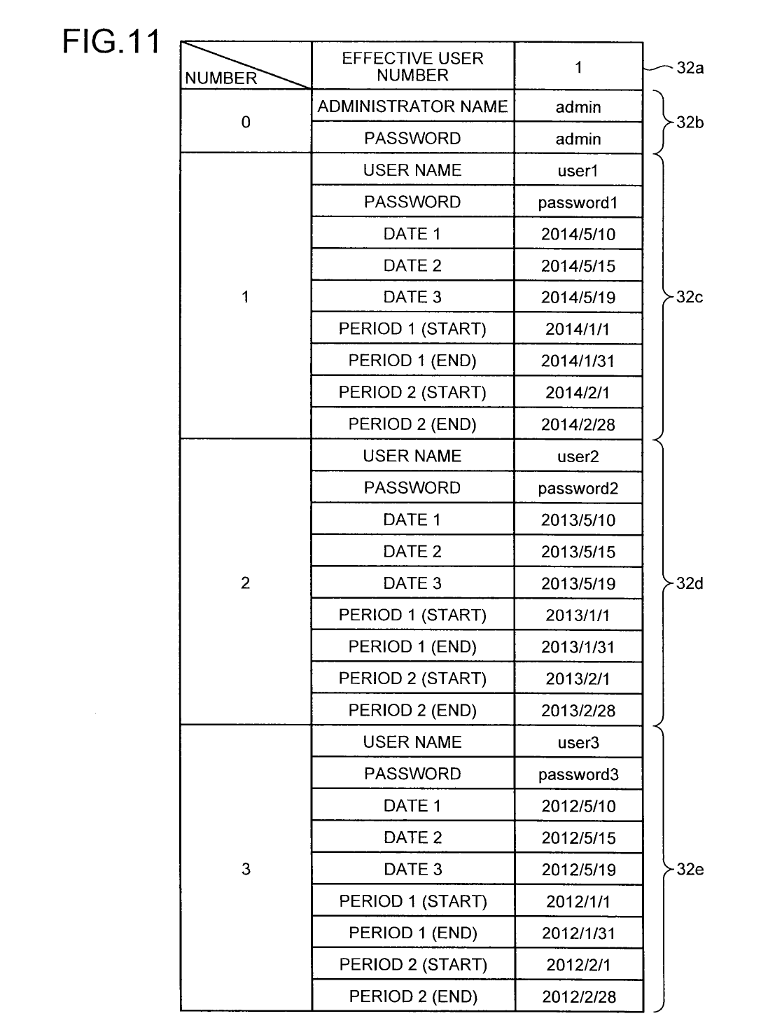

FIG. 11 illustrates a mapping of the access restriction information of the third embodiment. In FIG. 11, the access restriction information includes an effective user number 32a, administrator information 32b, and multiple pieces of user management information 32c to 32e. The effective user number 32a is used for identifying an accessible current user. In the entry of the user number 0, the administrator information 32b is registered. In the administrator information 32b, a administrator name and a password are registered.

The user management information 32c for the first user includes a mapping of a user name, a password, and multiple pieces of permissible period information for selecting the file to be made accessible within the NAND 10. The user management information 32d for the second user includes a mapping of a user name, a password, and multiple pieces of permissible period information for selecting the file to be made accessible within the NAND 10. The user management information 32e for the third user includes a mapping of a user name, a password, and multiple pieces of permissible period information for selecting the file to be made accessible within the NAND 10.

In the permissible period information of each user management information 32c to 32e, multiple pieces of date information and multiple pieces of period information can be set. In the period information, a start date and an end date of the period are set. The registration process of such access restriction information is performed similarly to the process illustrated in FIGS. 3A-3E and FIGS. 4A-4E. Further, the setting procedure of the effective user number is performed also similarly to the procedure illustrated in FIG. 5. In the case of FIG. 11, the user number “1” corresponding to the first user “user1” is selected.

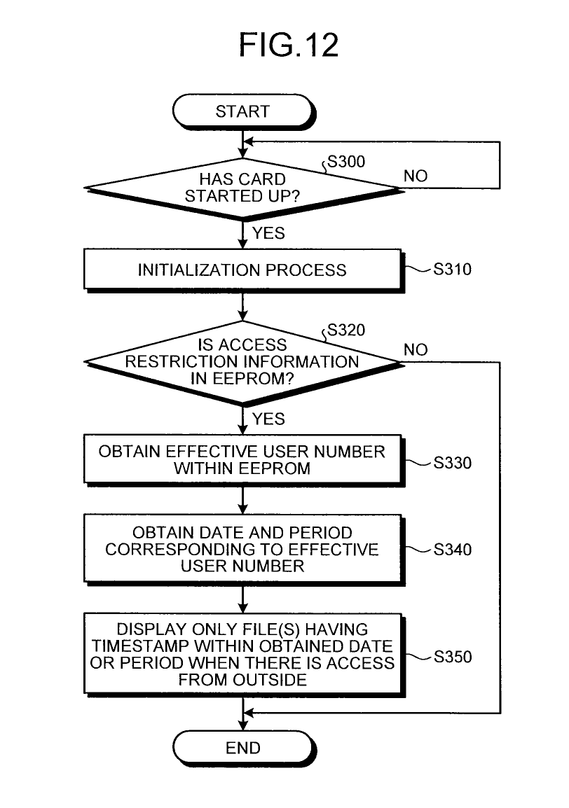

FIG. 12 is a flowchart illustrating the operation procedure at the startup of a memory card 100 in the third embodiment. In response to the action where the memory card 100 is inserted in the card slot of a host device 2, the memory card 100 is supplied with the power source and then starts up. In response to the startup of the memory card (step S300), a NAND controller 20 executes the above-described initialization process (step S310). In response to the action where the initialization process is started, the NAND controller 20 transmits a busy signal to the host device 2. Then, after the process of step S340 has been completed, the NAND controller 20 transmits a ready signal to the host device 2. Upon receiving the ready signal form the memory card 100, the host device 2 is able to access the file within the NAND 10.

Upon completion of the initialization process, the NAND controller 20 determines whether or not there is access restriction information written in an EEPROM 50 (step S320) and, if not, terminates the startup process performed at the startup. When having detected access restriction information in the EEPROM 50, the NAND controller 20 acquires the effective user number 32a within the access restriction information from the EEPROM 50 (step S330). Furthermore, the NAND controller 20 acquires, from the EEPROM 50, the permissible period information registered in the entry of the user management information corresponding to the acquired effective user number 32a (step S340). Then, when there is an access to the NAND 10 from the host device 2, only a part of the files having the timestamp within the range of the permissible period acquired at step S340 is displayed and only the part of the files is made accessible (step S350). When multiple periods are set as the permissible period information, the file whose timestamp is included in any of the set multiple periods is selected as the accessible file.

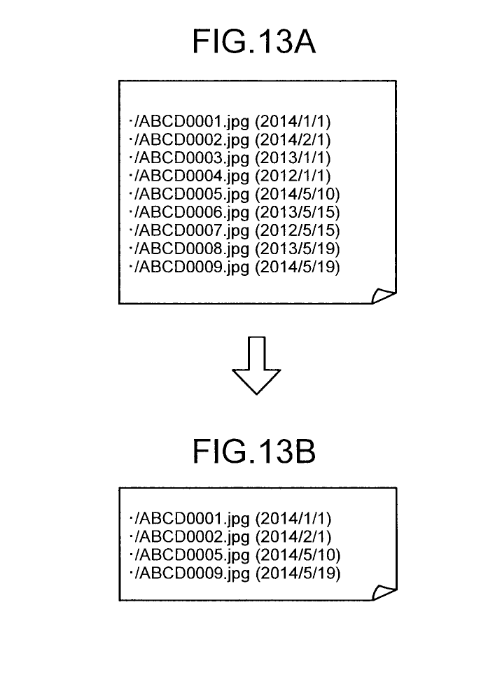

FIG. 13A illustrates a plurality of files saved in the user area in the NAND 10. The plurality of files has the timestamp depicted beside the file name as the metadata.

FIG. 13B illustrates the files that are visible from the host device 2 at step S350 of FIG. 12 when 1 is set as the effective user number. In this case, since 1 is set as the effective user number, the date information of May 10, 2014, the date information of May 15, 2014, the date information of May 19, 2014, the period information from Jan. 1, 2014 to Jan. 31, 2014, and the period information from Feb. 1, 2014 to Feb. 28, 2014 are set as the effective period information, as illustrated in FIG. 11. Therefore, only a part of the files whose timestamp is included in any range of these multiple set periods is displayed and the part of the files only is made accessible. In FIG. 13B, the files having the timestamps of the years of 2012 and 2013 that are out of the effective period information are determined to be non-accessible and thus not displayed.

As described above, in the third embodiment, the host device 1 having the NFC-communication function is used to set the permissible range of the timestamp of the files to be made accessible within the memory card on a user basis. Upon starting up of the card, the access restriction is applied according to the settings in the NFC communication. Therefore, in the third embodiment, the access restriction to the files having the different timestamp is enabled for each user of the memory card, which allows the user to implement the convenient and specific access restriction.

It is noted that the above-described embodiments may be applied to memory devices other than the memory card, such as a solid state drive (SSD), a hard disk drive (HDD), and so on. Further, other than the folder, the file name, the extension, and the timestamp, other metadata such as the file size and the like may be employed as the metadata for identifying the file to be subjected to the access restriction.

While certain embodiments have been described herein, these embodiments have been presented by way of example only, and are not intended to limit the scope of the present invention. Indeed, the novel embodiments described herein may be embodied in a variety of other embodiments; furthermore, various omissions, substitutions and changes in the form of the embodiments described herein may be made without departing from the spirit of the invention. The accompanying claims and their equivalents are intended to cover such embodiments or modifications as would fall within the scope and spirit of the invention.

What is claimed is:

1. A memory device comprising:
a nonvolatile first memory;
a nonvolatile second memory having a larger capacity than the first memory;
a first controller configured to register, to the first memory, access restriction information received over a short-range radio communication by using power generated in the short-range radio communication; and
a second controller configured to, at a startup of the memory device, read the access restriction information registered in the first memory and perform an access restriction to a file stored in the second memory based on the read access restriction information.

2. The memory device according to claim 1,
wherein the access restriction information includes multiple pieces of user management information and control information for selecting effective user management information out of the multiple pieces of user management information, and each user management information includes a mapping of a user name, a password, and metadata for identifying a file stored in the second memory, and
wherein the second controller selects one piece of user management information based on the control information and performs the access restriction based on the selected user management information.

3. The memory device according to claim 2,
wherein one or a plurality of folder names is registered for the metadata, and
wherein the second controller causes a folder having a folder name matching a registered folder name to be accessible.

4. The memory device according to claim 2,
wherein one or a plurality of folder names is registered for the metadata, and
wherein the second controller causes a folder having a folder name not matching a registered folder name to be accessible.

5. The memory device according to claim 2,
wherein one or a plurality of extension names is registered for the metadata, and
wherein the second controller causes an extension having a folder name matching a registered extension name to be accessible.

6. The memory device according to claim 2,
wherein one or a plurality of permissible periods of a timestamp is registered for the metadata, and
wherein the second controller causes a file having a timestamp included in a registered permissible period of a timestamp to be accessible.

7. The memory device according to claim 2,
wherein one or a plurality of permissible periods of a timestamp is registered for the metadata, and
wherein the second controller causes a file having a timestamp not included in a registered permissible period of a timestamp to be accessible.

8. The memory device according to claim 6, wherein the permissible period of the timestamp includes a date, a start date, and an end date.

9. The memory device according to claim 7, wherein the permissible period of the timestamp includes a date, a start date, and an end date.

10. The memory device according to claim 1, wherein the short-range radio communication is an NFC.

11. The memory device according to claim 1, wherein the first memory is an EEPROM.

12. The memory device according to claim 1, wherein the second memory is a NAND-type flash memory.

13. A memory controller connected to a nonvolatile first memory and a nonvolatile second memory, the second memory having a larger capacity than the first memory, the memory controller comprising:
a first controller configured to register, to the first memory, access restriction information received over a short-range radio communication by using power generated in the short-range radio communication; and
a second controller configured to, at a startup of the memory device, read the access restriction information registered in the first memory and perform an access restriction to a file stored in the second memory based on the read access restriction information.

14. The memory controller according to claim 13,
wherein the access restriction information includes multiple pieces of user management information and control information for selecting effective user management information out of the multiple pieces of user management information, and each user management information includes a mapping of a user name, a password, and metadata for identifying a file stored in the second memory, and
wherein the second controller selects one piece of user management information based on the control information and performs the access restriction based on the selected user management information.

15. The memory controller according to claim 14,
wherein one or a plurality of folder names is registered for the metadata, and
wherein the second controller causes a folder having a folder name matching a registered folder name to be accessible.

16. The memory controller according to claim 14,
wherein one or a plurality of extension names is registered for the metadata, and
wherein the second controller causes an extension having a folder name matching a registered extension name to be accessible.

17. The memory controller according to claim 14,
wherein one or a plurality of permissible periods of a timestamp is registered for the metadata, and
wherein the second controller causes a file having a timestamp included in a registered permissible period of a timestamp to be accessible.

18. A control method of a memory device comprising a nonvolatile first memory and a nonvolatile second memory, the second memory having a larger capacity than the first memory, the method comprising:
registering, to the first memory, access restriction information received over a short-range radio communication by using power generated in the short-range radio communication; and
at a startup of the memory device, reading the access restriction information registered in the first memory, and performing an access restriction to a file stored in the second memory based on the read access restriction information.

19. The method according to claim 18,
wherein the access restriction information includes multiple pieces of user management information and control information for selecting effective user management information out of the multiple pieces of user management information, and each user management information includes a mapping of a user name, a password, and metadata for identifying a file stored in the second memory,
the method further comprising selecting one piece of user management information based on the control information, and performing the access restriction based on the selected user management information.

20. The method according to claim 18,
wherein one or a plurality of folder names is registered for the metadata,
the method further comprising causing a folder having a folder name matching a registered folder name to be accessible.
